(19) United States
(12) Patent Application Publication
(10) Pub. No.: US 2026/0247235 A1
(43) Pub. Date: Aug. 20, 2026

(54) METHOD OF HANDLING DETECTION OF FAKE CELL INDEX, USER EQUIPMENT, AND CHIP

(71) Applicant: GUANGDONG OPPO MOBILE TELECOMMUNICATIONS CORP., LTD., Dongguan (CN)

(72) Inventor: Xin YOU, Dongguan (CN)

(21) Appl. No.: 19/646,512

(22) Filed: Apr. 13, 2026

Related U.S. Application Data
(63) Continuation of application No. PCT/CN2024/131629, filed on Nov. 12, 2024.
(60) Provisional application No. 63/548,374, filed on Nov. 13, 2023.

(51) Int. Cl. H04W 36/04; H04W 12/0431; H04W 12/121; H04W 74/0838; H04W 76/19

(52) U.S. Cl. CPC H04W 36/04; H04W 12/0431; H04W 12/121; H04W 74/0838; H04W 76/19

(57) ABSTRACT

A method of handling detection of a fake cell index performed by a user equipment (UE) includes performing a detection of a fake candidate or target cell index during a lower-layer triggered mobility (LTM) cell switch procedure, including one or more of following operations: triggering a radio resource control (RRC) re-establishment procedure in response to detecting the fake candidate or target cell index during the LTM cell switch procedure, refreshing a security key, notifying a network entity, selecting an LTM candidate cell for accessing, releasing an LTM configuration, suspending or stopping layer 1(L1 ) measurements on LTM candidate cells, suspending or stopping an L1 measurement reporting for the LTM candidate cell, triggering a secondary cell group (SCG) or main cell group (MCG) failure information procedure, or disabling an LTM-related procedure.

### CROSS REFERENCE TO RELATED APPLICATION(S)

This application is a continuation of International Application No. PCT/CN2024/131629, filed Nov. 12, 2024, which claims priority to U.S. Provisional Application No. 63/548,374, filed Nov. 13, 2023, the disclosures of which are hereby incorporated by reference in their entireties.

### TECHNICAL FIELD

The present disclosure relates to the field of communication systems, and more particularly, to a method of handling detection of a fake cell index, a user equipment (UE), and a chip.

### RELATED ART

In legacy systems, a handover command is transmitted to a user equipment (UE) within a ciphered radio resource control (RRC) reconfiguration message via a packet data convergence protocol (PDCP). 3rd Generation Partnership Project (3GPP) Release 18 introduced lower-layer triggered mobility (LTM) to reduce handover interruption time and signaling overhead, allowing a primary cell (PCell) or a primary secondary cell (PSCell) switches through medium access control (MAC) control elements based on layer 1 (L1) measurements. Unlike higher-layer signaling, lower-layer signaling in LTM lacks security protections such as ciphering and integrity verification, making a target cell index in an LTM cell switch MAC control element susceptible to tampering.

Therefore, there is a need for apparatuses and methods of handling detection of a fake cell index.

### SUMMARY

In a first aspect of the present disclosure, a method of handling detection of a fake cell index performed by a user equipment (UE) includes performing a detection of a fake candidate or target cell index during a lower-layer triggered mobility (LTM) cell switch procedure, including one or more of following operations: triggering a radio resource control (RRC) re-establishment procedure in response to detecting the fake candidate or target cell index during the LTM cell switch procedure, refreshing a security key, notifying a network entity, selecting an LTM candidate cell for accessing, releasing an LTM configuration, suspending or stopping layer 1 (L1) measurements on LTM candidate cells, suspending or stopping an L1 measurement reporting for the LTM candidate cell, triggering a secondary cell group (SCG) or main cell group (MCG) failure information procedure, or disabling an LTM-related procedure.

In a second aspect of the present disclosure, a user equipment (UE) includes a memory, a transceiver, and a processor coupled to the memory and the transceiver. The UE is configured to perform the above method.

In a third aspect of the present disclosure, a chip includes a processor, configured to call and run a computer program stored in a memory, to cause a device in which the chip is installed to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a block diagram of a UE according to an embodiment of the present disclosure.

FIG. 5 is a block diagram of a UE according to an embodiment of the present disclosure.

FIG. 6 is a flowchart illustrating a method of handling detection of a fake cell index performed by a UE according to an embodiment of the present disclosure.

FIG. 7 is a block diagram of an example of a computing device according to an embodiment of the present disclosure.

FIG. 8 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

In legacy systems, a handover command is contained in a radio resource control (RRC) reconfiguration message, which is transmitted to a user equipment (UE) and ciphered by a packet data convergence protocol (PDCP). 3GPP Release 18 introduced lower-layer triggered mobility (LTM) (such as layer 1/layer 2 (L1/L2)-triggered mobility) to reduce handover (HO) interruption time and signaling overhead. This is a cell switch procedure for a primary cell (PCell) or a primary secondary cell (PSCell) that involves a cell group change, triggered by a network via a medium access control (MAC) control element (CE) based on layer 1 (L1) measurements.

In the current specification, security protections such as ciphering and integrity protection are not applied to lower-layer signaling. The Release 18 LTM cell switch execution procedure is triggered by the LTM cell switch MAC CE, which is neither ciphered nor integrity-protected. As a result, the target cell index included in the LTM cell switch MAC CE is vulnerable to tampering.

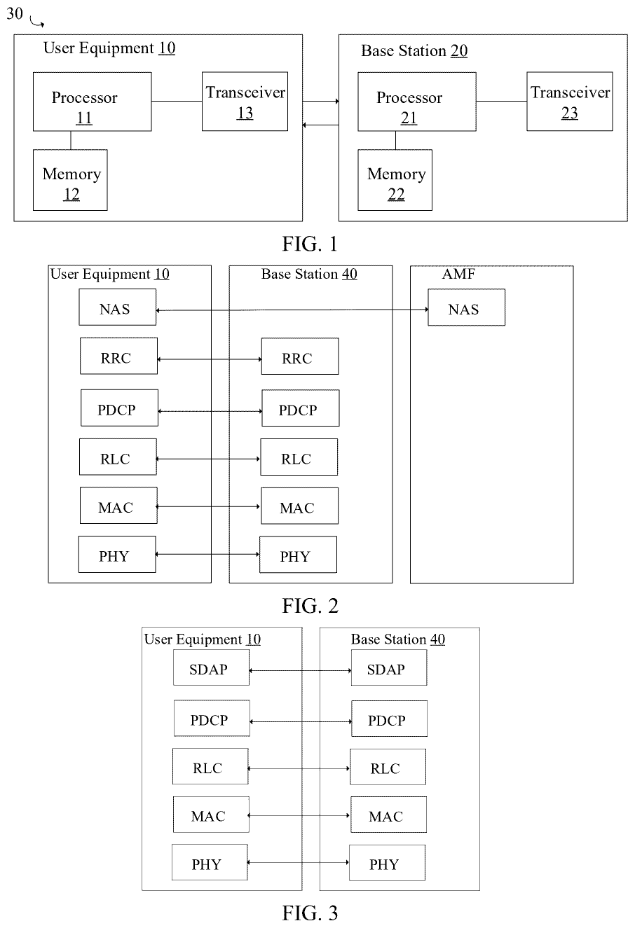

FIG. 1 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to perform a detection of a fake candidate or target cell index during a lower-layer triggered mobility (LTM) cell switch procedure, including one or more of following operations: triggering a radio resource control (RRC) re-establishment procedure in response to detecting the fake candidate or target cell index during the LTM cell switch procedure, refreshing a security key, notifying a network entity, selecting an LTM candidate cell for accessing, releasing an LTM configuration, suspending or stopping layer 1 (L1) measurements on LTM candidate cells, suspending or stopping an L1 measurement reporting for the LTM candidate cell, triggering a secondary cell group (SCG) or main cell group (MCG) failure information procedure, or disabling an LTM-related procedure. This can solve issues in the prior art and other issues, avoid a handover to a wrong cell, and/or avoid a service interruption.

In some embodiments, the processor 21 is condigured to indiciate the UE 10 to perform a detection of a fake candidate or target cell index during a lower-layer triggered mobility (LTM) cell switch procedure, including one or more of following operations: indiciating the UE 10 to trigger a radio resource control (RRC) re-establishment procedure in response to detecting the fake candidate or target cell index during the LTM cell switch procedure, refreshing a security key, receiving a notify from the UE 10, indiciating the UE 10 to select an LTM candidate cell for accessing, indiciating the UE 10 to release an LTM configuration, indiciating the UE 10 to suspend or stop layer 1 (L1) measurements on LTM candidate cells, indiciating the UE 10 to suspend or stop an L1 measurement reporting for the LTM candidate cell, indiciating the UE 10 to trigger a secondary cell group (SCG) or main cell group (MCG) failure information procedure, or indiciating the UE 10 to disable an LTM-related procedure. This can solve issues in the prior art and other issues, avoid a handover to a wrong cell, and/or avoid a service interruption.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, the UE 10 is configured to perform a detection of a fake candidate or target cell index during a lower-layer triggered mobility (LTM) cell switch procedure, including one or more of following operations: triggering a radio resource control (RRC) re-establishment procedure in response to detecting the fake candidate or target cell index during the LTM cell switch procedure, refreshing a security key, notifying a network entity, selecting an LTM candidate cell for accessing, releasing an LTM configuration, suspending or stopping layer 1 (L1) measurements on LTM candidate cells, suspending or stopping an L1 measurement reporting for the LTM candidate cell, triggering a secondary cell group (SCG) or main cell group (MCG) failure information procedure, or disabling an LTM-related procedure. This can solve issues in the prior art and other issues, avoid a handover to a wrong cell, and/or avoid a service interruption.

In some embodiments, the base station 40 is condigured to indiciate the UE 10 to perform a detection of a fake candidate or target cell index during a lower-layer triggered mobility (LTM) cell switch procedure, including one or more of following operations: indiciating the UE 10 to trigger a radio resource control (RRC) re-establishment procedure in response to detecting the fake candidate or target cell index during the LTM cell switch procedure, refreshing a security key, receiving a notify from the UE 10, indiciating the UE 10 to select an LTM candidate cell for accessing, indiciating the UE 10 to release an LTM configuration, indiciating the UE 10 to suspend or stop layer 1 (L1) measurements on LTM candidate cells, indiciating the UE 10 to suspend or stop an L1 measurement reporting for the LTM candidate cell, indiciating the UE 10 to trigger a secondary cell group (SCG) or main cell group (MCG) failure information procedure, or indiciating the UE 10 to disable an LTM-related procedure. This can solve issues in the prior art and other issues, avoid a handover to a wrong cell, and/or avoid a service interruption.

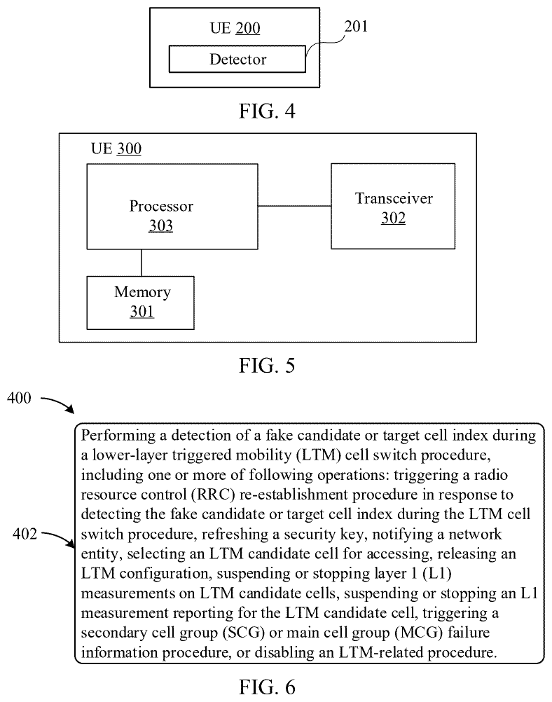

FIG. 4 illustrates an example of a UE 200 according to an embodiment of the present application. The UE 200 is configured to implement some embodiments of the disclosure. Some embodiments of the disclosure may be implemented into the UE 200 using any suitably configured hardware and/or software. The UE 200 includes a detector 201 configured to perform a detection of a fake candidate or target cell index during a lower-layer triggered mobility (LTM) cell switch procedure, including one or more of following operations: triggering a radio resource control (RRC) re-establishment procedure in response to detecting the fake candidate or target cell index during the LTM cell switch procedure, refreshing a security key, notifying a network entity, selecting an LTM candidate cell for accessing, releasing an LTM configuration, suspending or stopping layer 1 (L1) measurements on LTM candidate cells, suspending or stopping an L1 measurement reporting for the LTM candidate cell, triggering a secondary cell group (SCG) or main cell group (MCG) failure information procedure, or disabling an LTM-related procedure. This can solve issues in the prior art and other issues, avoid a handover to a wrong cell, and/or avoid a service interruption.

FIG. 5 illustrates an example of a UE 300 according to an embodiment of the present disclosure. The UE 300 is configured to implement some embodiments of the disclosure. Some embodiments of the disclosure may be implemented into the UE 300 using any suitably configured hardware and/or software. The UE 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the processor 303 is configured to perform a detection of a fake candidate or target cell index during a lower-layer triggered mobility (LTM) cell switch procedure, including one or more of following operations: triggering a radio resource control (RRC) re-establishment procedure in response to detecting the fake candidate or target cell index during the LTM cell switch procedure, refreshing a security key, notifying a network entity, selecting an LTM candidate cell for accessing, releasing an LTM configuration, suspending or stopping layer 1 (L1) measurements on LTM candidate cells, suspending or stopping an L1 measurement reporting for the LTM candidate cell, triggering a secondary cell group (SCG) or main cell group (MCG) failure information procedure, or disabling an LTM-related procedure. This can solve issues in the prior art and other issues, avoid a handover to a wrong cell, and/or avoid a service interruption.

In some embodiments, refreshing the security key includes refreshing the security key by performing a packet data convergence protocol (PDCP) re-establishment. In some embodiments, notifying the network entity includes one or more of following operations: triggering a security issue report upon detection of the fake candidate or target cell index, setting a cause of the security issue report to indicate a fake candidate or target cell condition, transmitting the security issue report to a master node (MN) or a secondary node (SN), or selectively transmitting the security issue report immediately upon detection of an anomaly in a cell identification or after the UE has resolved a security issue. In some embodiments, selecting the LTM candidate cell for accessing includes selecting the LTM candidate cell based on a cell quality for accessing. In some embodiments, disabling the LTM-related procedure includes disabling the LTM-related procedure within an RRC layer of the UE, wherein the RRC layer of the UE further indicates a lower layer to stop or cancel the LTM cell switch procedure.

In some embodiments, the UE is configured to declare the fake candidate or target cell index according to one or more of following conditions: wherein a target cell index indicated in a cell switch command is not one of preconfigured candidate cell indexes, wherein the target cell index indicated in the cell switch command is equal to a candidate cell index of a source serving cell, wherein the target cell index indicated in the cell switch command is equal to the candidate cell index with a lowest cell quality, wherein a transmission configuration indicator (TCI) state indicated in the cell switch command does not match a corresponding TCI state list configuration, or wherein contention free random access (CFRA) resources indicated in the cell switch command do not match a corresponding random access channel (RACH) resource configuration. In some embodiments, an RRC layer of the UE performs a verification of the candidate or target cell index upon reception of an indication from one or more lower layers, and the RRC layer of the UE or the UE determines whether to trigger the LTM cell switch procedure.

In some embodiments, the candidate cell index is indicated in the LTM cell switch command, and the LTM cell switch command is used to trigger the LTM cell switch procedure. In some embodiments, upon reception of the LTM cell switch command, a medium access control (MAC) layer of the UE informs an RRC layer of the UE that the target cell index is contained in the LTM cell switch command. In some embodiments, upon receiving an indication from an RRC layer of the UE, the UE performs one or more of following operations: performing a MAC reset, executing the LTM cell switch procedure with or without a random access channel (RACH) involvement, or applying a timing adjustment (TA), a transmission configuration indicator (TCI) state, or RACH resources.

FIG. 6 is an example of a method 400 of handling detection of a fake cell index performed by a UE according to an embodiment of the present disclosure. The method 400 of handling detection of a fake cell index performed by a UE is configured to implement some embodiments of the disclosure. Some embodiments of the disclosure may be implemented into the method 400 of handling detection of a fake cell index performed by a UE using any suitably configured hardware and/or software. In some embodiments, the method 400 of handling detection of a fake cell index performed by a UE includes: an operation 402, performing a detection of a fake candidate or target cell index during a lower-layer triggered mobility (LTM) cell switch procedure, including one or more of following operations: triggering a radio resource control (RRC) re-establishment procedure in response to detecting the fake candidate or target cell index during the LTM cell switch procedure, refreshing a security key, notifying a network entity, selecting an LTM candidate cell for accessing, releasing an LTM configuration, suspending or stopping layer 1 (L1) measurements on LTM candidate cells, suspending or stopping an L1 measurement reporting for the LTM candidate cell, triggering a secondary cell group (SCG) or main cell group (MCG) failure information procedure, or disabling an LTM-related procedure. This can solve issues in the prior art and other issues, avoid a handover to a wrong cell, and/or avoid a service interruption.

In some embodiments, refreshing the security key includes refreshing the security key by performing a packet data convergence protocol (PDCP) re-establishment. In some embodiments, notifying the network entity includes one or more of following operations: triggering a security issue report upon detection of the fake candidate or target cell index, setting a cause of the security issue report to indicate a fake candidate or target cell condition, transmitting the security issue report to a master node (MN) or a secondary node (SN), or selectively transmitting the security issue report immediately upon detection of an anomaly in a cell identification or after the UE has resolved a security issue. In some embodiments, selecting the LTM candidate cell for accessing includes selecting the LTM candidate cell based on a cell quality for accessing. In some embodiments, disabling the LTM-related procedure includes disabling the LTM-related procedure within an RRC layer of the UE, wherein the RRC layer of the UE further indicates a lower layer to stop or cancel the LTM cell switch procedure.

In some embodiments, the method further includes declaring the fake candidate or target cell index according to one or more of following conditions: wherein a target cell index indicated in a cell switch command is not one of preconfigured candidate cell indexes, wherein the target cell index indicated in the cell switch command is equal to a candidate cell index of a source serving cell, wherein the target cell index indicated in the cell switch command is equal to the candidate cell index with a lowest cell quality, wherein a transmission configuration indicator (TCI) state indicated in the cell switch command does not match a corresponding TCI state list configuration, or wherein contention free random access (CFRA) resources indicated in the cell switch command do not match a corresponding random access channel (RACH) resource configuration.

In some embodiments, an RRC layer of the UE performs a verification of the candidate or target cell index upon reception of an indication from one or more lower layers, and the RRC layer of the UE or the UE determines whether to trigger the LTM cell switch procedure. In some embodiments, the candidate cell index is indicated in the LTM cell switch command, and the LTM cell switch command is used to trigger the LTM cell switch procedure. In some embodiments, upon reception of the LTM cell switch command, a medium access control (MAC) layer of the UE informs an RRC layer of the UE that the target cell index is contained in the LTM cell switch command. In some embodiments, upon receiving an indication from an RRC layer of the UE, the UE performs one or more of following operations: performing a MAC reset, executing the LTM cell switch procedure with or without a random access channel (RACH) involvement, or applying a timing adjustment (TA), a transmission configuration indicator (TCI) state, or RACH resources.

### Exemplary Technical Solutions

In some embodiments, if a fake candidate or target cell index is detected during the LTM cell switch procedure, the UE performs the following actions: a. Triggers the RRC re-establishment procedure, b. Refreshes the security key, c. Reports the issue to the network, d. Selects another LTM candidate for access, e. Releases the LTM configuration, f. Suspends or stops Layer 1 (L1) measurements on LTM candidate cells, g. Suspends or stops L1 measurement reporting for the LTM candidate cell, h. Triggers the SCG/MCG failure information procedure, and/or i. Ceases performing any LTM-related procedures (The UE does not perform LTM related procedure). These operations ensure that the UE can effectively respond to and mitigate issues arising from a fake candidate or target cell index during lower-layer triggered mobility (LTM) cell switch operations.

In some embodiments, if a fake candidate or target cell index is detected during the LTM cell switch procedure, the UE performs the following actions: a. Triggers an RRC re-establishment procedure, b. Refreshes the security key, for example, by performing PDCP re-establishment, c. Reports the issue to the network, setting the cause as “fake candidate/target cell.” This security issue report is sent to the master node (MN) or secondary node (SN). The UE can send the report immediately after detecting the fake candidate/target cell index or after the UE has resolved the security issue, d. Selects another LTM candidate cell for access based on cell quality, e. Releases the LTM configuration, f. Suspends or stops Layer 1 (L1) measurements on LTM candidate cells, g. Suspends or stops L1 measurement reporting for the LTM candidate cell, h. Triggers the secondary cell group (SCG) or main cell group (MCG) failure information procedure, and/or i. Ceases LTM-related procedures at the RRC level and may also instruct the lower layers to stop or cancel the triggered LTM cell switch procedure. This can ensure network integrity and secure connectivity.

In some embodiments, a fake candidate or target cell index is declared if any of the following conditions are met: the target cell index indicated in the cell switch command is not one of the preconfigured candidate cell indexes, or the target cell index in the cell switch command matches the candidate cell index of the source serving cell (where the current source serving cell is configured as a candidate), or the target cell index in the cell switch command corresponds to the candidate cell index with the lowest cell quality, the transmission configuration indicator (TCI) state in the cell switch command does not align with the configured TCI state list, and/or the contention-free random access (CFRA) resources indicated in the cell switch command do not match the corresponding random access channel (RACH) resource configuration. In some embodiments, the RRC layer of the UE verifies the candidate or target cell index upon receiving an indication from one or more lower layers of the UE, after which the RRC layer of the UE/UE determines whether to trigger LTM.

In some embodiments, the candidate cell index is specified in the LTM cell switch command, which is used to trigger LTM execution. Upon receiving the LTM cell switch command, the MAC entity informs the RRC (upper layer) of the target cell index contained in the LTM cell switch command. In some embodiments, following an RRC indication, the UE performs one or more of the following operations: performs a MAC reset, executes RACH-based or RACH-less LTM execution, applies the indicated timing adjustment (TA), TCI state, and/or RACH resources, if provided.

In some embodiments, if a fake candidate or target cell index is detected during the LTM cell switch procedure, the UE performs a series of actions to maintain network integrity, including triggering RRC re-establishment, refreshing the security key, reporting the issue to the network, selecting an alternative LTM candidate based on cell quality, releasing the LTM configuration, and suspending Layer 1 (L1) measurements and reporting on the compromised cell. Additionally, the UE may initiate SCG/MCG failure information procedures and cease LTM-related actions, potentially instructing lower layers to stop or cancel the cell switch. A fake candidate or target cell index is declared if certain conditions are met, such as mismatches in preconfigured candidate cell indexes, TCI state list, or CFRA resources. Upon detection, the RRC layer verifies the candidate or target cell index and determines whether to proceed with LTM. In other embodiments, the MAC entity informs the RRC of the target cell index in the LTM cell switch command, prompting the UE to perform further actions such as a MAC reset, RACH-based or RACH-less LTM execution, and applying any specified timing adjustments, TCI state, or RACH resources. In some embodiments, the proposed solution can prevent handover to an incorrect cell, thereby avoiding unnecessary service interruptions.

Commercial interests for some embodiments are as follows. 1. Solve issues in the prior art and other issues. 2. Avoid a handover to a wrong cell. 3. Avoid a service interruption. 4. Maintain service continuity. 5. Provide a good communication performance. 6. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of wireless communication are considered for standardizing.

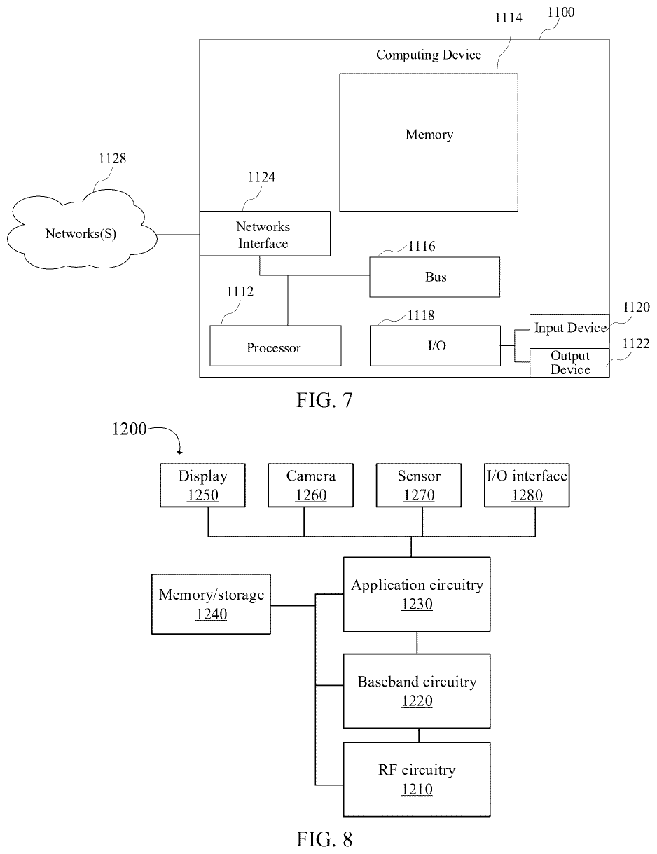

FIG. 7 is an example of a computing device 1100 according to an embodiment of the present disclosure. Any suitable computing device can be used for performing the operations described herein. For example, FIG. 7 illustrates an example of the computing device 1100 that can implement some embodiments of FIG. 1 to FIG. 6 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 6. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 8 is a block diagram of an example of a communication system 1200 according to an embodiment of the present disclosure. Embodiments described herein may be implemented into the communication system 1200 using any suitably configured hardware and/or software. FIG. 8 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 6. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 6 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and operations described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the operations disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of handling detection of a fake cell index performed by a user equipment (UE), comprising:
performing a detection of a fake candidate or target cell index during a lower-layer triggered mobility (LTM) cell switch procedure, comprising one or more of following operations:
triggering a radio resource control (RRC) re-establishment procedure in response to detecting the fake candidate or target cell index during the LTM cell switch procedure;
refreshing a security key;
notifying a network entity;
selecting an LTM candidate cell for accessing;
releasing an LTM configuration;
suspending or stopping layer 1 (L1) measurements on LTM candidate cells;
suspending or stopping an L1 measurement reporting for the LTM candidate cell;
triggering a secondary cell group (SCG) or main cell group (MCG) failure information procedure; or
disabling an LTM-related procedure.

2. The method of claim 1, wherein refreshing the security key comprises:
refreshing the security key by performing a packet data convergence protocol (PDCP) re-establishment.

3. The method of claim 1, wherein notifying the network entity comprises one or more of following operations:
triggering a security issue report upon detection of the fake candidate or target cell index;
setting a cause of the security issue report to indicate a fake candidate or target cell condition;
transmitting the security issue report to a master node (MN) or a secondary node (SN); or
selectively transmitting the security issue report immediately upon detection of an anomaly in a cell identification or after the UE has resolved a security issue.

4. The method of claim 1, wherein selecting the LTM candidate cell for accessing comprises:
selecting the LTM candidate cell based on a cell quality for accessing.

5. The method of claim 1, wherein disabling the LTM-related procedure comprises:
disabling the LTM-related procedure within an RRC layer of the UE, wherein the RRC layer of the UE further indicates a lower layer to stop or cancel the LTM cell switch procedure.

6. The method of claim 1, further comprising declaring the fake candidate or target cell index according to one or more of following conditions:
wherein a target cell index indicated in a cell switch command is not one of preconfigured candidate cell indexes;
wherein the target cell index indicated in the cell switch command is equal to a candidate cell index of a source serving cell;
wherein the target cell index indicated in the cell switch command is equal to the candidate cell index with a lowest cell quality;
wherein a transmission configuration indicator (TCI) state indicated in the cell switch command does not match a corresponding TCI state list configuration; or
wherein contention free random access (CFRA) resources indicated in the cell switch command do not match a corresponding random access channel (RACH) resource configuration.

7. The method of claim 6, wherein an RRC layer of the UE performs a verification of the candidate or target cell index upon reception of an indication from one or more lower layers, and the RRC layer of the UE or the UE determines whether to trigger the LTM cell switch procedure.

8. The method of claim 6, wherein the candidate cell index is indicated in the LTM cell switch command, and the LTM cell switch command is used to trigger the LTM cell switch procedure.

9. The method of claim 8, wherein upon reception of the LTM cell switch command, a medium access control (MAC) layer of the UE informs an RRC layer of the UE that the target cell index is contained in the LTM cell switch command.

10. The method of claim 1, wherein upon receiving an indication from an RRC layer of the UE, the UE performs one or more of following operations:
performing a MAC reset;
executing the LTM cell switch procedure with or without a random access channel (RACH) involvement; or
applying a timing adjustment (TA), a transmission configuration indicator (TCI) state, or RACH resources.

11. A user equipment (UE), comprising:
a memory;
a transceiver; and
a processor coupled to the memory and the transceiver;
wherein the UE is configured to perform a detection of a fake candidate or target cell index during a lower-layer triggered mobility (LTM) cell switch procedure, comprising one or more of following operations:
triggering a radio resource control (RRC) re-establishment procedure in response to detecting the fake candidate or target cell index during the LTM cell switch procedure;
refreshing a security key;
notifying a network entity;
selecting an LTM candidate cell for accessing;
releasing an LTM configuration;
suspending or stopping layer 1 (L1) measurements on LTM candidate cells;
suspending or stopping an L1 measurement reporting for the LTM candidate cell;
triggering a secondary cell group (SCG) or main cell group (MCG) failure information procedure; or
disabling an LTM-related procedure.

12. The UE of claim 11, wherein refreshing the security key comprises:
refreshing the security key by performing a packet data convergence protocol (PDCP) re-establishment.

13. The UE of claim 11, wherein notifying the network entity comprises one or more of following operations:
triggering a security issue report upon detection of the fake candidate or target cell index;
setting a cause of the security issue report to indicate a fake candidate or target cell condition;
transmitting the security issue report to a master node (MN) or a secondary node (SN); or
selectively transmitting the security issue report immediately upon detection of an anomaly in a cell identification or after the UE has resolved a security issue.

14. The UE of claim 11, wherein selecting the LTM candidate cell for accessing comprises:
selecting the LTM candidate cell based on a cell quality for accessing.

15. The UE of claim 11, wherein disabling the LTM-related procedure comprises:
disabling the LTM-related procedure within an RRC layer of the UE, wherein the RRC layer of the UE further indicates a lower layer to stop or cancel the LTM cell switch procedure.

16. The UE of claim 11, wherein the UE is configured to declare the fake candidate or target cell index according to one or more of following conditions:
wherein a target cell index indicated in a cell switch command is not one of preconfigured candidate cell indexes;
wherein the target cell index indicated in the cell switch command is equal to a candidate cell index of a source serving cell;
wherein the target cell index indicated in the cell switch command is equal to the candidate cell index with a lowest cell quality;
wherein a transmission configuration indicator (TCI) state indicated in the cell switch command does not match a corresponding TCI state list configuration; or
wherein contention free random access (CFRA) resources indicated in the cell switch command do not match a corresponding random access channel (RACH) resource configuration.

17. The UE of claim 16, wherein an RRC layer of the UE performs a verification of the candidate or target cell index upon reception of an indication from one or more lower layers, and the RRC layer of the UE or the UE determines whether to trigger the LTM cell switch procedure.

18. The UE of claim 16, wherein the candidate cell index is indicated in the LTM cell switch command, and the LTM cell switch command is used to trigger the LTM cell switch procedure.

19. The UE of claim 18, wherein upon reception of the LTM cell switch command, a medium access control (MAC) layer of the UE informs an RRC layer of the UE that the target cell index is contained in the LTM cell switch command.

20. A chip, including:
a processor, configured to execute a computer program stored in a memory, to cause a device in which the chip is installed to:
perform a detection of a fake candidate or target cell index during a lower-layer triggered mobility (LTM) cell switch procedure, comprising one or more of following operations:
triggering a radio resource control (RRC) re-establishment procedure in response to detecting the fake candidate or target cell index during the LTM cell switch procedure;
refreshing a security key;
notifying a network entity;
selecting an LTM candidate cell for accessing;
releasing an LTM configuration;
suspending or stopping layer 1 (L1) measurements on LTM candidate cells;
suspending or stopping an L1 measurement reporting for the LTM candidate cell;
triggering a secondary cell group (SCG) or main cell group (MCG) failure information procedure; or
disabling an LTM-related procedure.
